(19) United States
(12) Patent Application Publication
(10) Pub. No.: US 2014/0064872 A1
(43) Pub. Date: Mar. 6, 2014

(54) Replaceable Anchor

(71) Applicant: FAR EAST UNIVERSITY, Tainan City (TW)

(72) Inventor: Hsiang-Chi Wu, Tainan City (TW)

(73) Assignee: FAR EAST UNIVERSITY, Tainan City (TW)

(21) Appl. No.: 13/948,231

(22) Filed: Jul. 23, 2013

(30) Foreign Application Priority Data
Aug. 31, 2012 (TW) 101216896

(51) Int. Cl. F16B 13/08

(52) U.S. Cl. CPC F16B 13/0841
USPC 411/60.2

(57) ABSTRACT

A replaceable anchor contains a body, and the body includes an extension, at least one slot, a screwing stem, and a nut. The extension is hollowly tubular and has the at least one slot defined thereon and the screwing stem inserting through and extending out of the extension so as to screw with the nut. The extension has a circular rib extending outwardly around one end thereof and being perpendicular to the extension, such that the extension is fixed into the hole, and the circular rib contacts with the wall.

### FIELD OF THE INVENTION

The present invention relates to a replaceable anchor which is fixed into a wall of a building so as to decorate the building or hang an object in the building.

### BACKGROUND OF THE INVENTION

A conventional anchor is fixed into a wall and cannot be removed since it does not have a head rib formed on one end thereof. Accordingly, when the conventional anchor is too old to be used again, a user has to drill another hole in the wall and fix a new anchor into the hole, thus damaging the wall.

The present invention has arisen to mitigate and/or obviate the afore-described disadvantages.

### SUMMARY OF THE INVENTION

The primary object of the present invention is to provide a replaceable anchor which is capable of overcoming the shortcomings of the conventional anchor.

Further object of the present invention is to provide a replaceable anchor which is fixed in and removed from the hole of the wall easily.

Another object of the present invention is to provide a replaceable anchor which maintains the hole completely without drilling another hole after removing the replaceable anchor from the hole of the wall.

To obtain the above objectives, a replaceable anchor contains a body, and the body includes an extension, at least one slot, a screwing stem, and a nut. The extension is hollowly tubular and has the at least one slot defined thereon and the screwing stem inserting through and extending out of the extension so as to screw with the nut.

The extension has a circular rib extending outwardly around one end thereof and being perpendicular to the extension, such that the extension is fixed into the hole, and the circular rib contacts with the wall.

### BRIEF DESCRIPTION OF THE DRAWINGS

FIG. 1 is a perspective view showing the assembly of a replaceable anchor according to a preferred embodiment of the present invention.

FIG. 2 is a cross sectional view showing the operation of the replaceable anchor according to the preferred embodiment of the present invention.

### DETAILED DESCRIPTION OF THE PREFERRED EMBODIMENTS

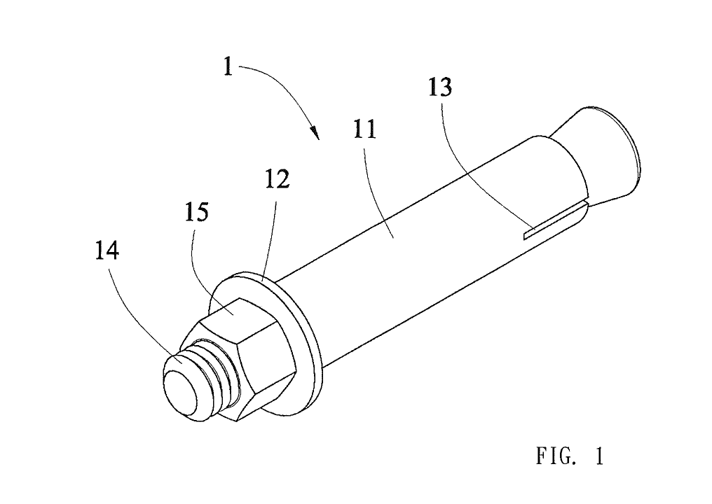

With reference to FIG. 1, a replaceable anchor according to a preferred embodiment of the present invention comprises: a body 1, and the body 1 includes an extension 11, a circular rib 12, at least one slot 13, a screwing stem 14, and a nut 15. The extension 11 is hollowly tubular and has the circular rib 12 extending outwardly around one end thereof and being perpendicular to the extension 11. The extension 11 also has the at least one slot 13 defined thereon and the screwing stem 14 inserting through and extending out of the extension 11 so as to screw with the nut 15.

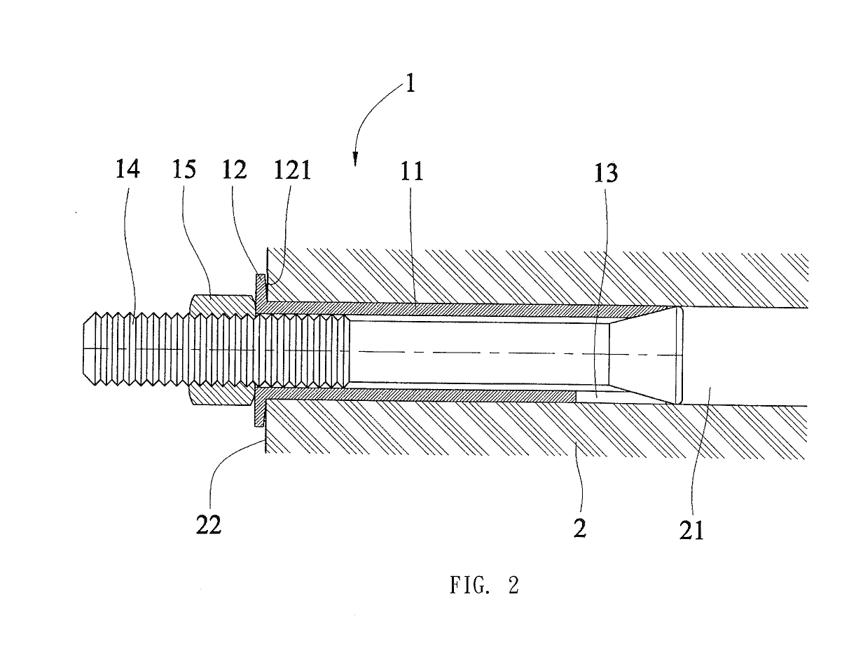

As illustrated in FIG. 2, as desiring to fix the body 1 into a wall 2, a hole 21 is drilled on the wall 2 so that the extension 11 and the screwing stem 14 of the body 1 are fixed into the hole 21, and then the nut 15 is screwed with the screwing stem 14 so that a distal end of the screwing stem 14 forces the extension 11 into the hole 21, thus fixing the extension 11 into the hole 21 and contacting the circular rib 12 with an outer surface 22 of the wall 2. When desiring to remove the body 1 from the hole 21 of the wall 2, the nut 15 is removed firstly, and then the screwing stem 14 is hit so that the extension 11 removes from the hole 21, and then a tool is placed between the circular rib 12 and the outer surface 22, thereafter the tool is pulled outwardly by means of a lever principle, such that the circular rib 12 drives the extension 11 to move out of the hole 21, thus remaining the hole 21 completely.

As shown in FIG. 2, in order to pull the body 1 out of the hole 21 easily, a tilted face 121 is arranged on an inner side of the circular rib 12 such that the tool is placed between the circular rib 12 and the outer surface 22 easily by ways of the tilted face 121.

Thereby, the replaceable anchor of the present invention is fixed into and removed from the hole easily, and the hole is maintained completely without drilling another hole after removing the replaceable anchor from the hole of the wall.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A replaceable anchor comprising:
a body, and the body including an extension, at least one slot, a screwing stem, and a nut; the extension being hollowly tubular and having the at least one slot defined thereon and the screwing stem inserting through and extending out of the extension so as to screw with the nut; characterized in that
the extension has a circular rib extending outwardly around one end thereof, such that the extension is fixed into the hole, and the circular rib contacts with the wall.

2. The replaceable anchor as claimed in claim 1, wherein the circular rib is perpendicular to the extension.

3. The replaceable anchor as claimed in claim 1, wherein the circular rib has a tilted face arranged on an inner side thereof.
